(19) United States
(12) Patent Application Publication
(10) Pub. No.: US 2009/0304429 A1
(43) Pub. Date: Dec. 10, 2009

(54) IMAGE FORMING APPARATUS

(75) Inventor: Jirou Makinodan, Kashiwa-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/478,868

(22) Filed: Jun. 5, 2009

(30) Foreign Application Priority Data
Jun. 6, 2008 (JP) 2008-149048

(51) Int. Cl. G03G 15/00

(52) U.S. Cl. 399/406

(57) ABSTRACT

There is a provided a curl corrector which corrects a curl formed by a fixer when a duplex image formation mode is selected. The curl corrector is provided in a conveying path other than conveying paths commonly used in a conveying path for multiple image formation and a conveying path for duplex image formation.

### BACKGROUND OF THE INVENTION

1. Field of the Invention

The present invention relates to an electrophotographic system image forming apparatus (hereinafter referred to as an image forming apparatus) such as a copier, a printer, a recorded image display device, and a facsimile forming a visible image by an electrophotographic system.

2. Description of the Related Art

An electrophotographic system image forming apparatus is widely used in, for example, a complex machine and a facsimile having a copier function and a printer function.

In an image forming apparatus using the electrophotographic system, a visible image carried on a photoreceptor or a transfer member is transferred to a sheet such as plain paper to thereby obtain a recorded image. Therefore, the sheet to which the visible image is transferred from the photoreceptor or the transfer member is conveyed to a fixer, and the visible image on the sheet is fixed by the fixer. Thereafter, the sheet is discharged to the outside of the image forming apparatus.

When an image is formed on the back side of a sheet, as illustrated in FIG. 4, the sheet on which an image is transferred and fixed on the front side is drawn into an inverting path 110 to be thereafter switchbacked, and thus, to be guided into a duplex conveying path 111, whereby the sheet is resupplied to an image forming part. When an image is formed on the same side of the sheet several times, a sheet on which an image is transferred and fixed on the front side is not inverted to be drawn into a multiple conveying path 112 as it is, and thus, to be resupplied to the image forming part. A conveying path for guiding a sheet into the duplex conveying path or the multiple conveying path is generally curved, and it is more advantageous for reducing the size of the main body that the conveying path is curved with as large a curvature as possible.

However, a curl may be formed in the sheet by heat or pressure applied when the sheet passes through the fixer, and the curled sheet may cause jamming and corner folding during the conveyance of the sheet. Further, the curled sheet enters a transfer part with an attitude different from the attitude of the sheet free from a curl in the first image formation, and therefore, a toner image is disturbed by the influence of an electric field in the transfer part, leading to image failure or dispersion of toner.

In the image forming apparatus disclosed in Japanese Patent Laid-Open Publication No. 11-199142, as illustrated in FIG. 4, a curl is generated in a fixer 101. In order to remove the curl, a curl corrector 102 is provided immediately after the fixer 101. The curl corrector 102 forms a curl in a sheet to thereby remove the curl generated in the fixer 101. The sheet from which the curl is removed is conveyed into the duplex conveying path 111 or the multiple conveying path 112.

In the image forming apparatus, the curl corrector 102 is disposed before the bifurcation of a discharge path, the duplex conveying path, and the multiple conveying path provided immediately after the fixer 101. Therefore, the curl formation is performed in the same direction as the time when the sheet enters the curl corrector 102 regardless of whether transferring and fixing on the back side or on the same side.

The curl corrector 102 of FIG. 4 forms a downward curl (which is, in the both ends in the conveying direction, more downward than the central portion) in a sheet. In this case, in the multiple image formation in which an image is formed on the same side several times, the sheet in which the downward curl is formed by the curl corrector 102 is again conveyed to an image transfer part in such a state of having the downward curl.

Meanwhile, in the duplex image formation in which an image is formed on the front and back sides of a sheet, the front and back sides of the sheet are reversed. Therefore, when the sheet is again conveyed to the image transfer part, the direction of a curl is reversed between the image formation to the back side of the image forming surface with the first image and the image formation to the same side. For example, when an image is formed on the back side of the sheet in which the downward curl is formed in the image formation to the front side of the sheet, the front and back sides of the sheet are inverted, and therefore, the sheet which is again conveyed to the image transfer part enters the image transfer part in such a state that an upward curl (which is, in the both ends in the conveying direction, is more upward than the central portion) is formed.

When the sheet enters the image transfer part, if a curl is formed in a direction that the end of the sheet approaches an image bearing member on which a toner image is formed (in FIG. 4, when the upward curl is formed in the sheet), the transfer failure may occur. This is because the front end of the sheet is in contact with an intermediate transfer member, which is an image bearing member, before entering a toner image transfer nip portion, leading to reduction of the conveyance performance. For example, in such a constitution that the intermediate transfer member is disposed upward of the conveying path of the sheet, when a sheet with the upward curl is conveyed to a secondary transfer nip portion, the transfer failure occurs.

In the image forming apparatus disclosed in Japanese Patent Laid-Open Publication No. 11-199142, the curl corrector is set so that when an image is formed on the back side of the image forming surface of the sheet, on which the first image is formed, the sheet is conveyed to the secondary transfer nip portion in such a state that the downward curl is formed in the sheet. In this case, when an image is formed on the same side as the image forming surface of the sheet on which the first image is formed, the upward curl is formed in the sheet to be conveyed to the secondary transfer nip portion, and therefore, the transfer failure may occur.

As described above, when the conventional image forming apparatus has a mode of forming an image on the same side of the sheet in a multiple manner and a mode of forming an image on the both sides, jamming, corner folding, and image failure may occur due to the curl formed in the sheet. Japanese Patent Laid-Open Publication No. 61-235350 discloses such a constitution that the curl correction is performed in the multiple printing, and the curl correction is not performed in the duplex printing. However, in the constitution, when the sheet passes through a fixing device, the downward curl is formed in the sheet, and when the sheet again passes through the image forming part, the transfer failure may occur. Further, in the constitution, a path in which a curl correcting device is not provided is bifurcated from a path with the curl correcting device, and in addition, in order to invert the front and back sides of the sheet, a path for switch-back conveying the sheet is separately provided. As a result, this constitution leads to the increase in size of the apparatus.

### SUMMARY OF THE INVENTION

An object of the present invention is to provide an image forming apparatus which can prevent the occurrence of jamming of a sheet, corner folding of a sheet, and image failure in a mode of forming an image on the same side of a sheet in a multiple manner and a mode of forming an image on the both sides of the sheet.

In order to achieve the above object, the image forming apparatus of the invention includes an image forming part which transfers an image on a sheet to fix the image on the sheet to thereby form the image on the sheet, a conveying path for again conveying a sheet, in which an image is formed on a first surface of the sheet by the image forming part, to the image forming part, and a curl corrector which is provided in the conveying path and corrects a curl of the sheet in which an image is formed by the image forming part. In the image forming apparatus, a multiple image formation mode in which an image is formed on the same side of a sheet several times and a duplex image formation mode in which an image is formed on the front and back sides of the sheet can be executed. The curl corrector corrects a curl of a sheet when the duplex image formation mode is selected, and does not correct the curl when the multiple image formation mode is selected.

According to the image forming apparatus of the invention, in an image forming apparatus having a mode in which an image can be formed on the same side of a sheet several times and a mode in which an image can be formed on the front and back sides of the sheet, the occurrence of jamming of a sheet, corner folding of a sheet, and image failure can be prevented in both the image formation modes.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus according to a first embodiment of the invention;

FIG. 2 is a schematic configuration diagram of an image forming apparatus according to a second embodiment of the invention;

FIG. 3 is a schematic configuration diagram of an image forming apparatus according to a third embodiment of the invention; and

FIG. 4 is a schematic configuration diagram of the conventional image forming apparatus.

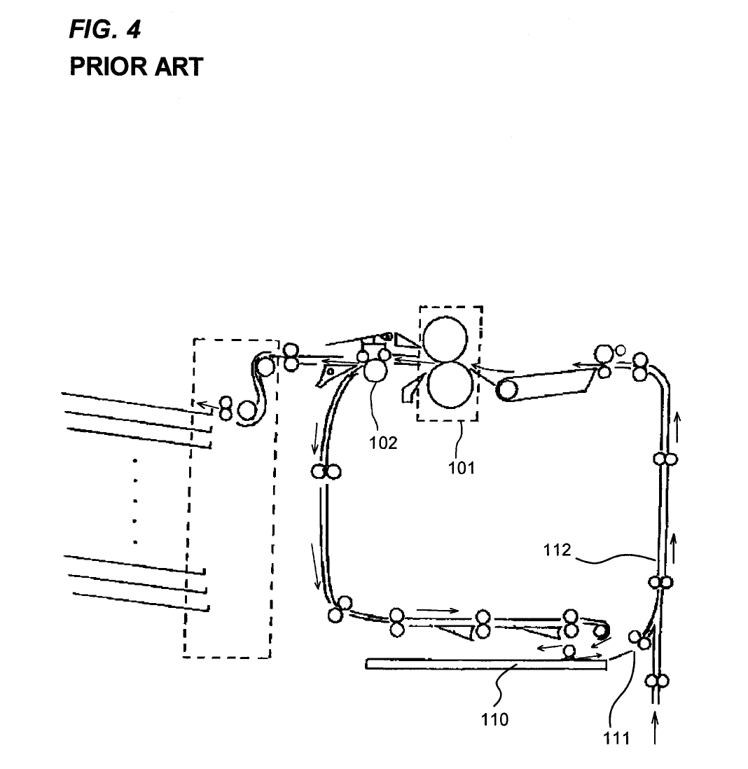

### DESCRIPTION OF THE EMBODIMENTS

Hereinafter, embodiments of the invention will be described in detail with reference to the drawings.

### First Embodiment

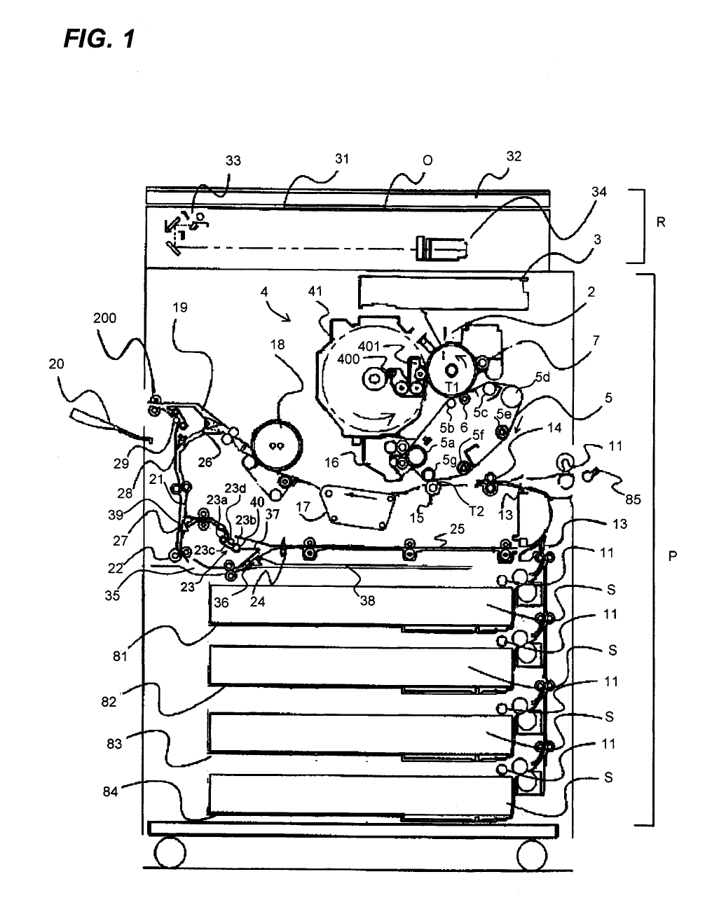

FIG. 1 is a schematic configuration diagram of an image forming apparatus according to a first embodiment of the invention. The image forming apparatus is an electrophotographic full color image forming apparatus and has in its upper portion a digital color image reader R and in its lower portion a digital color image printer P.

[Entire Configuration of Image Forming Apparatus]

The digital color image reader R includes an original stage glass 31 and an original pressing plate 32 openable and closable with respect to the original stage glass 31. A color original O is placed on the original stage glass 31 in accordance with a predetermined placement reference so that an image surface is directed downward, and the original pressing plate 32 is covered on the color original O to thereby set the color original O.

The original pressing plate 32 may be an original automatic feeding apparatus which automatically feeds a sheet-like original onto the original stage glass 31. The original pressing plate 32 may be an automatic feeding device for automatically feeding a double-sided original. A moving optical system 33 is driven to move along the lower surface of the original stage glass 31. A downward image surface of the color original O on the original stage glass 31 is optically scanned by the moving optical system 33. The original scanning light is formed on a CCD 34, which is a photoelectric conversion element (solid-image pickup element) to be read through color separation into three primary colors of RGB (red, green, and blue). Each signal of the read RGB is input to an image processing portion (not illustrated).

The digital color image printer P is an electrophotographic image forming mechanism having a one-drum rotary development configuration and an intermediate transfer configuration. The operational outline of the digital color image printer P is as follows.

An image signal is formed as an exposure image on an electrophotographic photosensitive drum (hereinafter referred to as a photosensitive drum) 1, which is an image bearing member, by means of a laser scanner 3.

A rotary development unit 4 including a plurality of development devices sequentially forms a toner image for each color on the exposure image formed on the photosensitive drum 1. The rotary development unit 4 accommodates a developer of a desired color in a development rotary 41 and includes a supply pipe 400 for use in supplying, as needed, a toner as a developer from a toner cartridge part (not illustrated).

The toner image of each color on the photosensitive drum 1 is further repeatedly primarily-transferred for each color on an intermediate transfer belt (hereinafter referred to as a belt) 5, and an unfixed toner image of a necessary color is synthesized and formed on the belt 5. Thereafter, the toner images are collectively secondarily-transferred on the sheet S to be then fixed, and thus, a full-color image formation is output.

Hereinafter, further details will be described. The photosensitive drum 1 is driven to rotate at a predetermined speed in a counter clockwise direction of the arrows, and the surface is uniformly changed at predetermined polarity and potential by a charger 2. The charged surface is subjected to laser scanning exposure by the laser scanner 3.

The laser scanner 3 has a laser output part, a polygon mirror, an imaging lens, and a turning back mirror. The laser scanner 3 outputs a laser light (optical signal) modulated in response to an image information signal input from an image processing portion (not illustrated) and scans and exposes the charged surface of the rotating photosensitive drum 1. According to this constitution, an electrostatic latent image corresponding to a scanning exposure pattern is formed on the surface of the photosensitive drum 1. The image information signal may be synthesized and formed by image information, electrically transmitted from an external device such as a personal computer, in addition to the image information read from the digital color image reader R.

The electrostatic latent image is developed as a toner image by the rotary development unit 4. The rotary development unit 4 mounts a plurality of development devices 401 with the development rotary 41 accommodated with each color developer (toner). The development rotary 41 is rotated in the illustrated arrow direction by a predetermined angle at a predetermined control timing, whereby each development device 401 is switched at a developing position opposed to the photosensitive drum 1 to be disposed in the developing position. In the developing position, the distance (SD distance) between the photosensitive drum 1 and a developing sleeve on the development device 401 side is maintained within a predetermined range.

The belt 5 is a flexible endless belt formed of a dielectric material and stretched and supported between a plurality of rollers 5a to 5g. The belt 5 on its outer surface is in contact with the photosensitive drum 1 between the rollers 5b and 5c. The contact portion is a primary transfer nip portion T1. In the primary transfer nip portion T1, a primary transfer roller 6 is disposed on the opposite side of the photosensitive drum 1 side of the belt 5 and is in contact with the inner surface of the belt 5. The primary transfer roller 6 undergoes a primary transfer voltage, having opposite polarity to that of a toner, at a predetermined control timing. The belt 5 is driven to rotate in a clockwise direction of the arrows at a speed substantially the same as the rotational speed of the photosensitive drum 1 by using, for example, the roller 5a as a drive roller.

First, a toner image of the first color is formed with respect to the photosensitive drum 1 by the image forming process including charging, exposure, and development. The toner image is transferred onto the belt 5 in the primary transfer nip portion T1. A primary transfer remaining toner, remaining on the surface of the photosensitive drum 1 without being transferred onto the belt 5, is removed from the surface of the photosensitive drum 1 by a drum cleaning device 7. The photosensitive drum 1 cleaned by the drum cleaning device 7 is repeatedly used in the image formation. The similar image forming process is repeated with respect to the toner images of the second to the Nth color, as needed. According to this constitution, an unfixed toner image is synthesized and formed on the belt 5 by sequentially superimposing and transferring the toner image of each development color.

Meanwhile, a feed roller 11 of a feeding part, previously selected from a plurality of feeding parts of sheet cassettes 81 to 84 or a multi manual tray 85, is driven at a predetermined control timing. According to this constitution, the uppermost one of the sheets S such as sheet-like papers accommodated in the feeding part is separated to be fed, and, thus, to be conveyed from a conveying path 13 to a registration roller 14. The registration roller 14 controls correction of the skew feeding of the sheet S and the timing of the secondary transfer of the toner image from the belt 5 to the sheet S, and receives the front end of the sheet S fed from the feeding part side to temporarily stop the sheet S.

A secondary transfer roller 15 is switched between a first state and a second state by a pressurization control mechanism (not illustrated), and the attachment/detachment state is controlled. In the first state, the secondary transfer roller 15 is in press-contact with the counter roller 5g of a plurality of rollers 5a to 5g of the belt 5 across the belt 5. In the second state, the secondary transfer roller 15 is spaced from the outer surface of the belt 5. The secondary transfer roller 15 is normally switched to and maintained in the second state of being spaced from the outer surface of the belt 5. The secondary transfer roller 15 is switched to the first state, whereby a secondary transfer nip portion T2 is formed between the secondary transfer roller 15 and the outer surface of the belt 5. The secondary transfer roller 15 is switched to the first state at a predetermined control timing. The sheet S temporarily stopped at the position of the registration roller 14 is resupplied from the registration roller 14 at a predetermined control timing, and introduced into the secondary transfer nip portion T2 between the secondary transfer roller 15, switched to the first state, and the belt 5. At this time, when the sheet S has the upward curl, the front end of the sheet S is jammed at the entrance of the nip portion, or it is difficult for the sheet S to enter or be conveyed to the nip portion, thereby leading to the transfer failure.

The sheet S is then conveyed while being nipped by the secondary transfer nip portion T2. During the conveyance of the sheet S, a predetermined secondary transfer voltage is applied to the secondary transfer roller 15, and the toner image having a plurality of colors on the belt 5 is electrostatically collectively transferred onto the sheet S, whereby an unfixed toner image is formed (transferred) on the sheet S.

The secondary transfer remaining toner, remaining on the surface of the belt 5 without being transferred onto the sheet, is removed from the belt surface by a belt cleaning device 16. The belt 5 cleaned by the belt cleaning device 16 is repeatedly used for the image formation. The belt cleaning device 16 is normally maintained in a state of being spaced from the outer surface of the belt 5. When the toner image from the belt 5 is secondarily transferred to the sheet S by the secondary transfer nip portion T2, the belt cleaning device 16 is switched to a state of being in contact with the outer surface of the belt 5 at a predetermined control timing.

The sheet S leaving the secondary transfer nip portion T2 separates from the surface of the belt 5, and is conveyed to a fixer 18, which is a fixing device, by a conveyance belt unit 17. The unfixed toner image is fused on the sheet S by heat and pressure to be a fixed image. The fixer 18 forms the downward curl in the sheet S. The sheet S leaving the fixer 18 passes through a conveying path 19 to be discharged on a discharge tray 20.

When an image is again transferred and fixed on the sheet S, the sheet S passes through sheet conveying paths 21, 35, 37, 38, 40, and 25. When a duplex image formation mode or a multiple image formation mode is selected, a sheet in which an image is formed on one side or a sheet formed with the first image leaves the fixer 18, and is again conveyed to the secondary transfer nip portion T2 while passing through these conveying paths in such a state that the front and back sides of the sheet S are inverted or not inverted.

[Curl Corrector]

A curl corrector 23 is provided in the sheet conveying path 40. The curl corrector 23 forms a curl in the conveyed sheet, and a bias roller 23d rotatably abuts against a belt 23c supported by rotatably drivable support rollers 23a and 23b. The sheet is conveyed between the belt 23c and the bias roller 23d in a state of being recessed in the side of the belt 23c, whereby a curl is formed.

As described later, when the multiple image formation mode is selected, the sheet does not pass through the sheet conveying path 40 in which the curl corrector 23 is disposed. When the duplex image formation mode is selected, the sheet conveying path 40 serves as the sheet conveying path. Thus, when the duplex image formation mode is selected, the curl corrector 23 corrects the curl formed in the sheet by the fixer 18.

[Multiple Image Formation Mode]

Hereinafter, the multiple image formation mode will be described in detail. In the mode, an image is formed on one side of the sheet S several times. The sheet S leaving the fixer 18 is guided into the conveying path 21 on the lower side of the drawing by a switch member 26 for switching the sheet conveying direction and conveyed into the conveying path 35 on the lower right side of the drawing. The conveying path 35 includes a switch member 36 provided on the right side of the drawing. When the switch member 36 rotates downward in FIG. 1, the sheet S is conveyed into the conveying path 37. When the switch member 36 rotates upward in the drawing, the sheet S is conveyed into the conveying path 38.

In the multiple image formation mode, the switch member 36 rotates downward in the drawing, whereby the sheet S is conveyed into the conveying path 37, the sheet position in the main scanning direction (depth and front direction) is detected by a lateral registration detecting sensor 24, and the sheet is conveyed into the conveying path 25. Namely, the sheet S passes through the conveying paths 21, 35, 37, and 25, and these conveying paths constitute a conveying path for multiple image formation.

In the multiple image formation mode, the sheet S does not pass through the curl corrector 23 provided in the conveying path 40, and thus the sheet S is never subjected to the curl correction from after the first image formation to when the sheet S is again conveyed to the secondary transfer nip portion T2. Therefore, since the sheet S is again conveyed to the secondary transfer nip portion T2 in a state of having the downward curl formed by the fixer 18, the transfer failure does not occur.

The positional information of the sheet end detected by the lateral registration detecting sensor 24 is used for correction of a write position in the main scanning direction of the first image. Therefore, even if a variation in the position in the main scanning direction of the sheet S occurs in the multiple conveying path, an image can be formed in a main scanning position substantially the same as that of the first image.

Thereafter, the sheet S again passes through the fixer to pass through the conveying path 19, and thus, to be discharged on the discharged tray 20 by a discharge roller 200.

[Duplex Image Formation Mode]

Subsequently, the duplex image formation mode will be described in detail. The sheet S leaving the fixer 18 is guided into the conveying path 21 on the lower side of the drawing by the switch member 26 to be conveyed into the conveying path 35 on the lower right side of the drawing. The switch member 36 of the conveying path 35, provided rightward of the drawing, rotates upward in the drawing, whereby the sheet S is conveyed into the conveying path 38. When the rear end of the sheet S is detected by an reversion sensor 39, an reversion roller 22 stops the conveyance and counterrotates after a predetermined time, and conveys the sheet S in the opposite direction. A switch member 27 is operated when the reversion roller 22 counterrotates, whereby the sheet S is conveyed into the conveying path 40 on the right side of the drawing, and further conveyed into the conveying path 25. Namely, the conveying paths 21, 35, 38, 40, and 25 constitute the conveying path for duplex image formation. The conveying paths 21, 35, and 25 are used in common in the conveying path for multiple image formation, and the conveying paths 38 and 40 are not used in the conveying path for multiple image formation. The conveying path 38 constitutes a conveying path for reversion.

When the sheet S is conveyed into the conveying path 40, the front and back sides of the sheet S is inverted by the conveyance after counterrotation of the reversion roller 22 and the operation of the switch member 36. Therefore, the direction of the downward curl formed by the fixer 18 is inverted. However, a reverse curl to the curl formed by the fixer 18 is formed by the curl corrector 23 provided in the conveying path 40, whereby when the sheet S is again conveyed to the secondary transfer nip portion T2, the sheet S has the downward curl, and therefore, the transfer failure does not occur.

The positional information of the sheet end detected by the lateral registration detecting sensor 24 is used for correction of the write position in the main scanning direction of the image on the back side of the sheet. Therefore, even if the variation in the position of the main scanning direction of the sheet S occurs in the duplex conveying path, the image can be formed in the main scanning position substantially the same as the first image.

Thereafter, the sheet S again passes through the fixer to pass through the conveying path 19, and thus, to be discharged onto the discharged tray 20 by a discharge roller 200.

A curl corrector 29 is provided in a conveying path used when the sheet S is discharged in a state of being reversed so that the front and back sides are reversed. The reversion roller 22 starts the reversion operation to invert and convey the sheet S upward in the drawing without operating the switch member 27. Thereafter, the sheet conveying direction is switched to the discharge roller side by a switch member 28. The downward curl is formed in the sheet S by the curl corrector 29, and the sheet S with the downward curl is discharged onto the discharged tray 20.

In order to keep the good replacement condition of the sheet S on the discharge tray 20, the downward curl is formed in the sheet S before the sheet S is discharged.

As described above, in the present embodiment, the curl corrector 23 is provided in the conveying path through which a sheet passes only when the duplex image formation mode is selected. Therefore, the conveyed sheet is not subjected to the curl correction in the multiple image formation mode, and it is subjected to the curl correction only in the duplex image formation mode. According to this constitution, either in the multiple image formation mode or in the duplex image formation mode, the transfer failure in the secondary transfer nip portion T2 due to the curl of the sheet S, formed by the fixer 18 and the curl corrector 23, does not occur.

In the image forming apparatus of the present embodiment, the conveying paths 35, 37, and 38 are, as illustrated in the drawings, provided downward of the conveying path 40, which is the conveying path after reversion of the sheet S in the duplex image formation; however, they can be provided upward in the drawing.

### Second Embodiment

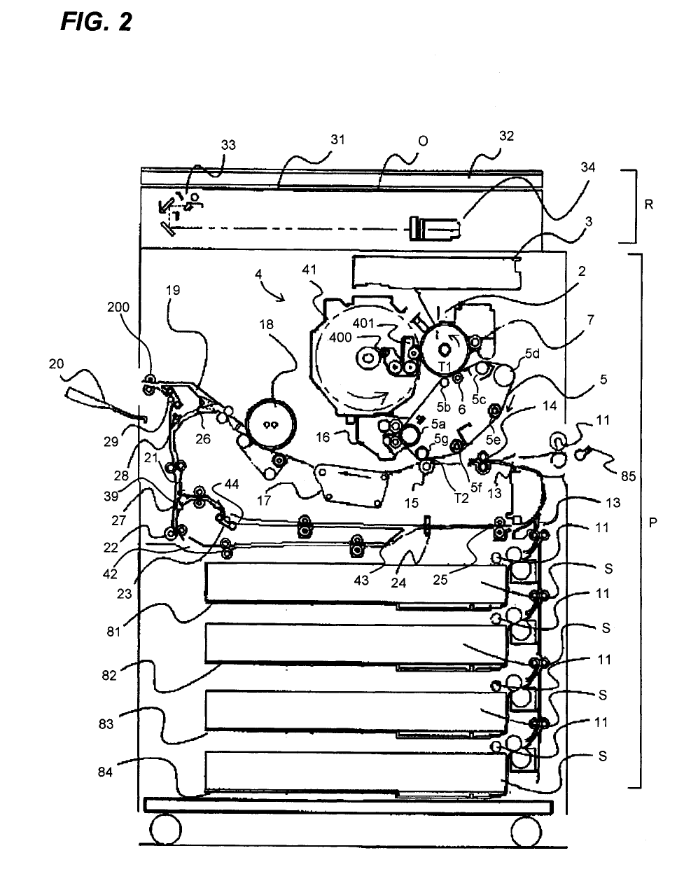

FIG. 2 is a view illustrating a schematic configuration of an image forming apparatus according to a second embodiment of the invention. In the image forming apparatus of the present embodiment, a sheet conveying path in the multiple image formation is provided on the extension of a drawing path for invention of the sheet S. The second embodiment is different from the first embodiment in the configuration from the conveying path 21 to the conveying path 25.

In FIG. 2, the components equivalent to those in FIG. 1 are assigned the same reference numerals, and the overlapped description is omitted. The image formation in the second embodiment is the same as the image formation in the first embodiment. The operation after the sheet S is conveyed to the lateral registration detecting sensor 24 in the multiple image formation mode and the duplex image formation mode is the same as the operation described in the first embodiment.

When an image is again transferred and fixed on the sheet S formed with the first image, the sheet S passes through the sheet conveying paths 21, 42, 43, 44, and 25. When the duplex image formation mode or the multiple image formation mode is selected, a sheet in which an image is formed on one side or a sheet formed with the first image leaves the fixer 18, and is again conveyed to the secondary transfer nip portion T2 while passing through these conveying paths in such a state that the front and back sides of the sheet S are inverted or not inverted.

The multiple image formation mode in the present embodiment will be described in detail. The sheet S leaving the fixer 18 is guided into the conveying path 21 on the lower side of the drawing by the switch member 26, and conveyed into the conveying path 42 on the lower side of the drawing. The conveying path 43 which is the downstream side of the conveying path 42 is formed continuous with the conveying path 25. The downstream side of the conveying path 44 through which the sheet S is conveyed in the duplex image formation is also formed continuous with the conveying path 25. Namely, the conveying paths 43 and 44 are formed continuous with the conveying path 25. The sheet S conveyed into the conveying path 42 is conveyed into the conveying path 43 as it is, the sheet position in the main scanning direction (depth and front direction) is detected by the lateral registration detecting sensor 24, and the sheet S is conveyed into the conveying path 25. Therefore, the conveying paths 21, 42, 43, and 25 constitute the conveying path for multiple image formation.

In the multiple image formation mode, the sheet S does not pass through the curl corrector 23 provided in the conveying path 44, and thus the sheet S is never subjected to the curl correction from after the first image formation to when the sheet S is again conveyed to the secondary transfer nip portion T2. Therefore, since the sheet S is again conveyed to the secondary transfer nip portion T2 in a state of having the downward curl formed by the fixer 18, the transfer failure does not occur.

Subsequently, the duplex image formation mode will be described in detail. The sheet S leaving the fixer 18 is guided into the conveying path 21 on the lower side of the drawing by the switch member 26 to be conveyed into the conveying path 42. When the rear end of the sheet S is detected by the reversion sensor 39, the reversion roller 22 stops the conveyance and counterrotates after a predetermined time, and conveys the sheet S in the opposite direction. The switch member 27 is operated when the reversion roller 22 counterrotates, whereby the sheet S is conveyed into the conveying path 44 on the right side of the drawing, and further conveyed into the conveying path 25. When the front end of the sheet S reaches the merging section of the conveying path 44 and the conveying path 25, the rear end of the sheet S retracts to the conveying path 43 or 42, and therefore, they do not interfere with the conveyance.

When the sheet S is again conveyed to the secondary transfer nip portion T2, the direction of the curl corrector 23 provided in the conveying path 44 is set so that the sheet S has the downward curl. The position of the sheet S in the main scanning direction (depth and front direction) is detected by the lateral registration detecting sensor 24, and the sheet S is further conveyed into the conveying path 25. Namely, the conveying paths 21, 42, 44, and 25 constitute the conveying path for duplex image formation. The conveying paths 21, 42, and 25 are used in common in the conveying path for multiple image formation, and the conveying path 44 is not used in the conveying path for multiple image formation.

As described above, either in the multiple image formation mode or in the duplex image formation mode, the transfer failure in the secondary transfer nip portion T2 due to the curl of the sheet S, formed by the fixer 18 and the curl corrector 23, does not occur.

In the image forming apparatus of the present embodiment, the conveying paths 42 and 43 are, as illustrated in the drawings, provided downward of the conveying path 44, which is the conveying path after reversion of the sheet S in the duplex image formation; however, they can be provided upward in the drawing.

### Third Embodiment

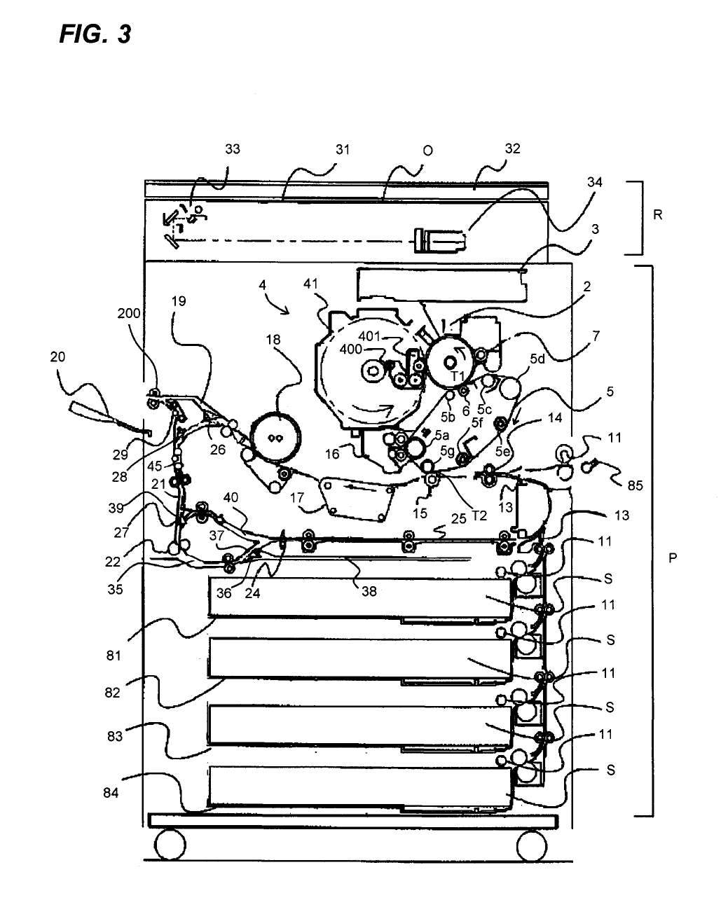

FIG. 3 is a view illustrating a schematic configuration of an image forming apparatus according to a third embodiment of the invention. In the image forming apparatus, a curl corrector is provided on the upstream side of the bifurcation of the multiple conveying path and the duplex conveying path.

Namely, the third embodiment is different from the first embodiment in the configuration from the switch member 26 to the conveying path 25. In FIG. 3, the components equivalent to those in FIG. 1 are assigned the same reference numerals, and the overlapped description is omitted. The image formation in the third embodiment is the same as the image formation in the first embodiment. The operation after the sheet S is conveyed to the lateral registration detecting sensor 24 in the multiple image formation mode and the duplex image formation mode is the same as the operation described in the first embodiment.

When an image is again transferred and fixed on the sheet S formed with the first image, the sheet S passes through the sheet conveying paths 21, 35, 37, 38, 40 and 25. When the duplex image formation mode or the multiple image formation mode is selected, a sheet in which an image is formed on one side or a sheet formed with the first image leaves the fixer 18, and is again conveyed to the secondary transfer nip portion T2 while passing through these conveying paths in such a state that the front and back sides of the sheet S are inverted or not inverted.

A curl corrector 45 is provided in the conveying path 21. The curl corrector 45 is set so that in the duplex image formation mode, when the front and back sides of the sheet S are inverted and the sheet is again conveyed to the secondary transfer nip portion T2, the sheet S is conveyed to the secondary transfer nip portion T2 in such a state that the downward curl is formed in the sheet S. The curl corrector 45 is provided with a pressure release mechanism (not illustrated). Even if the sheet S passes through the curl corrector 45, the curl correction is not performed upon pressure releasing. The operation of the pressure release mechanism is automatically switched in response to the image formation mode.

Hereinafter, the multiple image formation mode in the image forming apparatus of the present embodiment will be described in detail. The sheet S leaving the fixer 18 is guided into the conveying path 21 on the lower side of the drawing by the switch member 26 to be conveyed into the conveying path 35 on the lower right side of the drawing without being inverted in the reversion roller 22. The curl corrector 45 is provided in the conveying path 21; however, in the multiple image formation mode, the curl corrector 45 is pressure-released by a pressure release mechanism (not illustrated). According to this constitution, a curl is not formed in the sheet S by the curl corrector 45.

The switch member 36 is provided on the right side of the conveying path 35, as illustrated in the drawing. When the switch member 36 rotates downward in the drawing, the sheet S is conveyed into the conveying path 37. Meanwhile, when the switch member 36 rotates upward in the drawing, the sheet S is conveyed into the conveying path 38. In the multiple image formation mode, the switch member 36 rotates downward, whereby the sheet S is conveyed into the conveying path 37, the sheet position in the main scanning direction (depth and front direction) is detected by the lateral registration detecting sensor 24, and the sheet S is conveyed into the conveying path 25. Namely, the conveying paths 21, 35, 37, and 25 constitute the conveying path for multiple image formation.

In the multiple image formation mode, in order to prevent the curl formation by the curl corrector 45, the curl correction is never performed from after the first image formation to when the sheet S is again conveyed to the secondary transfer nip portion T2. Therefore, since the sheet S is again conveyed to the secondary transfer nip portion T2 in a state of having the downward curl formed by the fixer 18, the transfer failure does not occur.

Subsequently, the duplex image formation mode will be described in detail. The sheet S leaving the fixer 18 is guided into the conveying path 21 on the lower side of the drawing by the switch member 26 to be conveyed into the conveying path 35 on the lower right side of the drawing without being inverted in the reversion roller 22. In the duplex image formation mode, a curl is formed in the sheet S by the curl corrector 45 provided in the conveying path 21.

The switch member 36, which is, as illustrated in the drawing, provided on the right side of the conveying path 35, rotates upward in the drawing, whereby the sheet S is conveyed into the conveying path 38. When the rear end of the sheet S is detected by the reversion sensor 39, the reversion roller 22 stops the conveyance and counterrotates after a predetermined time, and conveys the sheet S in the opposite direction. The switch member 27 is operated when the reversion roller 22 counterrotates, whereby the sheet S is conveyed into the conveying path 40 on the right side of the drawing, and further conveyed into the conveying path 25. Namely, the conveying paths 21, 35, 38, 40, and 25 constitute the conveying path for duplex image formation. The conveying paths 21, 35, and 25 are used in common in the conveying path for multiple image formation.

The front and back sides of the sheet S are inverted when the sheet S is conveyed into the conveying path 40 by the conveyance after counterrotation of the reversion roller 22 and the operation of the switch member 36. In the duplex image formation mode, the downward curl is formed in the sheet S by the curl corrector 45 when the sheet is again conveyed to the secondary transfer nip portion T2, and therefore, the transfer failure does not occur.

As described above, either in the multiple image formation mode or in the duplex image formation mode, the transfer failure in the secondary transfer nip portion T2 due to the curl of the sheet S, formed by the fixer 18 and the curl corrector 45, does not occur.

In the image forming apparatus of the present embodiment, the conveying paths 35, 37, and 38 are, as illustrated in the drawing, provided downward of the conveying path 40; however, they may be provided upward in the drawing. Although the curl corrector 45 is provided on the conveying path 21 which is commonly used in the conveying path for multiple image formation and the conveying path for duplex image formation, it may be provided on the conveying path 25 which is the other common conveying path.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-149048, filed Jun. 6, 2008, which is hereby incorporated by reference herein in its entirety.

What is claimed is:

1. An image forming apparatus comprising:
an image forming part which transfers an image on a sheet to fix the image on the sheet to thereby form the image on the sheet;
a conveying path for again conveying a sheet, in which an image is formed on a first surface of the sheet by the image forming part, to the image forming part; and
a curl corrector which is provided in the conveying path and corrects a curl of the sheet in which an image is formed by the image forming part,
wherein a multiple image formation mode in which an image is formed on the same side of a sheet several times and a duplex image formation mode in which an image is formed on front and back sides of the sheet can be executed, and
the curl corrector corrects a curl of a sheet when the duplex image formation mode is selected, and does not correct the curl when the multiple image formation mode is selected.

2. The image forming apparatus according to claim 1, further comprising an inverting part which is provided in the conveying path and conveys a sheet in one direction to thereafter convey the sheet in another direction, wherein the conveying path comprises:
a conveying path for multiple image formation through which the sheet, in which an image is formed by the image forming part, passes when the multiple image formation mode is selected; and
a bifurcating path through which a sheet conveyed in the another direction by the inverting part passes and which bifurcates at a bifurcation position from the conveying path for multiple image formation and joins to the conveying path for multiple image formation at a joining position, and
the curl corrector is provided in the bifurcating path.

3. The image forming apparatus according to claim 1, wherein the curl corrector corrects a curl so that the curl is a downward curl when an image is transferred.
